(19) United States
(12) Patent Application Publication
(10) Pub. No.: US 2022/0108433 A1
(43) Pub. Date: Apr. 7, 2022

(54) INFORMATION PROCESSING APPARATUS, INFORMATION PROCESSING PROGRAM, AND INFORMATION PROCESSING METHOD

(71) Applicant: FUJITSU LIMITED, Kawasaki-shi (JP)

(72) Inventors: Takashi Fuse, Hadano (JP); Junji Tomita, Kawasaki (JP)

(73) Assignee: FUJITSU LIMITED, Kawasaki-shi (JP)

(21) Appl. No.: 17/552,354

(22) Filed: Dec. 16, 2021

Related U.S. Application Data
(63) Continuation of application No. PCT/JP2019/032302, filed on Aug. 19, 2019.

(51) Int. Cl. G06T 7/00; G06V 10/98; G06V 10/82; G06N 3/08; G06N 3/04

(52) U.S. Cl. CPC G06T 7/001; G06V 10/993; G06N 3/0454; G06N 3/08; G06V 10/82

(57) ABSTRACT

Provided is an information processing apparatus capable of acquiring a second inspection program capable of determining whether it is appropriate to cause a first inspection program, which has undergone machine learning so that acceptance of an acceptable image/unacceptable image may be determined, to determine acceptance of an unknown image. The information processing apparatus ranks, for pseudo pair images including acceptable images and unacceptable images obtained by performing pseudo image generation processing on determined pair images including acceptable images and unacceptable images, the pseudo pair images according to correctness of the acceptance determination by the first inspection program for each pair on the basis of results of the acceptance determination by the first inspection program, and by causing a mathematical model to undergo second machine learning that uses the determined pair images and a predetermined number or more of the ranked pseudo pair images as inputs.

### CROSS-REFERENCE TO RELATED APPLICATION

This application is a continuation application of International Application PCT/JP2019/032302 filed on Aug. 19, 2019 and designated the U.S., the entire contents of which are incorporated herein by reference.

### TECHNICAL FIELD

The present invention relates to an information processing apparatus, an information processing program, and an information processing method.

### BACKGROUND ART

Conventionally, there is a learning device including an acquisition unit that acquires a plurality of image pairs in which same subjects appear and a plurality of image pairs in which different subjects appear, and a setting unit that sets feature points on one image and the other image of each of the pairs acquired by the acquisition unit.

The learning device further includes a selection unit that selects a plurality of predetermined feature points set at same positions on the one image and the other image, so as to select feature extraction filters, which are used to extract a feature for each predetermined feature point of the predetermined feature points, and an extraction unit that extracts the feature for each of the predetermined feature points on each of the one image and the other image by using the plurality of feature extraction filters selected by the selection unit.

The learning device further includes a calculation unit that calculates a correlation between the features extracted by the extraction unit from the one image and the other image, and a learning unit that learns same-subject classifiers that identifies whether or not the same subjects appear in the two images, on the basis of the correlation calculated by the calculation unit and label information representing whether or not the subjects appearing in the one image and the other image are the same subjects (see, for example, Japanese Laid-open Patent Publication No. 2012-083938).

Examples of the related art include as follows: Japanese Laid-open Patent Publication No. 2012-083938.

### SUMMARY OF INVENTION

According to an aspect of the embodiments, there is provided an information processing apparatus including: a memory; and a processor coupled to the memory, the processor being configured to perform processing, the processing including: executing a first image acquisition processing that acquires a plurality of determined pair images that includes acceptable images and unacceptable images, for which acceptance has been correctly determined by a first inspection program that has undergone first machine learning; executing a first image generation processing that generates first pseudo pair images that includes acceptable images and unacceptable images obtained by performing first pseudo image generation processing on the acceptable images and the unacceptable images of the determined pair images; executing a determination result acquisition processing that acquires determination results obtained by determining, by the first inspection program, acceptance of the acceptable images and the unacceptable images of the first pseudo pair images; executing a ranking processing that ranks, on the basis of the determination results, the first pseudo pair images for which acceptance has been determined by the first inspection program, according to correctness of the determination for each pair; obtaining a mathematical model represented by a second inspection program that determines, when an acceptable image and an unacceptable image of pair images are input, whether it is appropriate to cause the first inspection program to determine acceptance of the acceptable image and the unacceptable image of the pair images; and executing a learning processing that causes the mathematical model to be trained by second machine learning that uses the determined pair images and the ranked first pseudo pair images as inputs, wherein the first image generation processing generates the first pseudo pair images until the number of the ranked first pseudo pair images becomes a first predetermined number or more, and by causing the mathematical model to be trained by the second machine learning that uses the determined pair images and the first predetermined number or more of the ranked first pseudo pair images as inputs, the learning processing trains the mathematical model such that, when an acceptable image and an unacceptable image of unknown pair images are input to the mathematical model, the mathematical model determines that it is appropriate to cause the first inspection program to determine acceptance of the acceptable image and the unacceptable image of the unknown pair images in a case where the acceptable image and the unacceptable image of the unknown pair images correspond to a predetermined rank or more, and determines that it is inappropriate to cause the first inspection program to determine acceptance of the acceptable image and the unacceptable image of the unknown pair images in a case where the acceptable image and the unacceptable image of the unknown pair images correspond to less than the predetermined rank.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a system 1 including an inspection program generation device 100 of an embodiment;

FIG. 2 is a perspective view of a computer system 20 that implements the inspection program generation device 100;

FIG. 3 is a block diagram for describing a configuration of main parts in a main body 21 of the computer system 20;

FIG. 4 is a diagram illustrating a configuration of the inspection program generation device 100;

FIG. 5 is a diagram illustrating examples of pair images of ranks 1 to 6;

FIG. 6 is a diagram illustrating image identification data handled by the inspection program generation device 100;

FIG. 7 is a diagram illustrating conditions relating to image evaluation by an inspection unit 11 and images for learning and for evaluation of a DNN 119;

FIG. 8 is a diagram illustrating distribution of determination results of acceptable images and unacceptable images of pseudo pair images 1 by the inspection unit 11;

FIG. 9 is a diagram illustrating distribution of determination results of acceptable images and unacceptable images of pseudo pair images 2 by the inspection unit 11;

FIG. 10 is a diagram illustrating a flowchart representing processing executed by a control device 110 of the inspection program generation device 100; and

FIG. 11 is a diagram illustrating the flowchart representing the processing executed by the control device 110 of the inspection program generation device 100.

### DESCRIPTION OF EMBODIMENTS

Incidentally, in the conventional learning device, in a case where there is an inspection program (first inspection program) that has undergone machine learning so as to be able to determine acceptance of images of non-defective products (acceptable products in an inspection) (acceptable image) and images of defective products (unacceptable products in the inspection) (unacceptable image) among mass-produced products, acceptance of the same type of inspection target as the learned mass-produced products is determined, and it is not determined whether it is appropriate to cause the first inspection program to determine acceptance of an unknown image.

For example, in a case where it takes time to perform or it takes time and effort such as preparatory work for performing machine learning such that acceptance determination as to whether an unknown image is an acceptable image or an unacceptable image may be made to obtain a result of the acceptance determination by the first inspection program, the first inspection program may be used effectively when it is possible to determine whether it is appropriate to cause the first inspection program to determine acceptance of an unknown image for which the first inspection program has not determined acceptance, before causing the first inspection program to make the determination.

Therefore, it is an object to provide an information processing apparatus, an information processing program, and an information processing method that are capable of obtaining a second inspection program that may determine whether it is appropriate to cause the first inspection program that has undergone machine learning so as to be able to make acceptance determination as to whether a mass-produced product is an acceptable image or an unacceptable image to determine acceptance of an unknown image.

Hereinafter, an embodiment to which an information processing apparatus, an information processing program, and an information processing method of the present invention is applied will be described.

### Embodiment

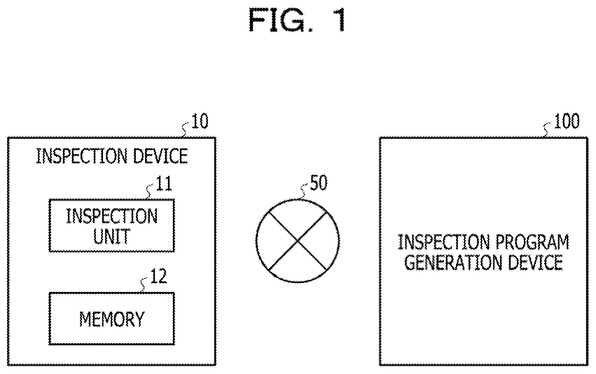

FIG. 1 is a diagram illustrating a system 1 including an inspection program generation device 100 of an embodiment. The system 1 includes an inspection device 10 and the inspection program generation device 100. The inspection device 10 and the inspection program generation device 100 are connected by a network 50 so that data communication is possible. The network 50 is a local area network (LAN), a wireless LAN (WLAN), a wide area network (WAN), or the like.

The inspection device 10 includes an inspection unit 11 and a memory 12. The inspection unit 11 represents a function implemented by installing an inspection program in the inspection device 10, and the memory 12 functionally represents a random access memory (RAM), a read only memory (ROM), and/or a hard disk drive (HDD), or the like of the inspection device 10.

The inspection program that implements the inspection unit 11 is an example of a first inspection program that has undergone first machine learning, and causes a part of a computer system that implements the inspection device 10 to function as the inspection unit 11.

As an example, the inspection program that implements the inspection unit 11 is a machine-learned program that has undergone machine learning so that an acceptable product and an unacceptable product may be accurately determined by using teacher data representing pair images of real images of acceptable products (non-defective products) and real images of unacceptable products (defective products) for products of the same type that are mass-produced (mass-produced products).

Here, being able to accurately determine an acceptable product and an unacceptable product means being able to determine an acceptable product and an unacceptable product at or above a predetermined probability (being able to determine acceptance), and the predetermined probability is, as an example, 95%.

Furthermore, the acceptable product is a mass-produced product that has passed an inspection as a result of the inspection performed by a human for predetermined mass-produced products, and the unacceptable product is a mass-produced product that has not passed an inspection as a result of the inspection performed by a human for predetermined mass-produced products.

Furthermore, the real image is an image obtained by light reflected by a subject as a result of irradiating the subject with light, and is typically a photographic image obtained by photographing the subject with a camera or the like. For example, the real image of the acceptable product is a real image of an acceptable product that has passed an inspection, and the real image of the unacceptable product is a real image of a mass-produced product that has not passed an inspection.

Furthermore, since the real image of the acceptable product and the real image of the unacceptable product are real images of an acceptable product and an unacceptable product for which a correct answer of either an acceptable product or an unacceptable product is known, the real images are data that may be used as the teacher data representing the pair images of the real images of the acceptable products and the real images of the unacceptable products.

Furthermore, the inspection program generation device 100 performs pseudo image generation processing on the real images of the acceptable product and the unacceptable product to generate pseudo images of the acceptable product and the unacceptable product.

Pseudo means being very similar and not easy to distinguish at first glance. Differences in shape, position, or the like due to individual differences among mass-produced products fall within a range of pseudo. Furthermore, the pseudo image generation processing is processing of generating pseudo images of the acceptable product and the unacceptable product, which are very similar to the real images of the acceptable product and the unacceptable product. A degree of similarity between the real images of the acceptable product and the unacceptable product and the pseudo images of the acceptable product and the unacceptable product may be adjusted by parameters or the like in the pseudo image generation processing.

Hereinafter, the real images of the acceptable product and the unacceptable product and the pseudo images of the acceptable product and the unacceptable product are ranked by 1 to 6.

Furthermore, hereinafter, an acceptable image and an unacceptable image of the rank 1 are the real image of the acceptable product and the real image of the unacceptable product, respectively. The rank 1 is the highest rank among the ranks 1 to 6.

Furthermore, the pseudo images of the acceptable product and the unacceptable product are ranked by 2 to 6. The rank 2 is the second highest rank, and the rank 6 is the lowest rank. Note that meaning and the like of the rank will be described later.

Although the inspection unit 11 has undergone machine learning by using teacher data representing pair images of real images of acceptable products and unacceptable products for predetermined mass-produced products of the same type that are mass-produced, as described above, since an inspection in which the inspection unit 11 determines acceptance involves various types of processing such as preparation, a relatively large amount of time is required. Furthermore, as the predetermined mass-produced products, products with various degrees of perfection are brought in from various customers and the like, and the inspection unit 11 makes acceptance determination on the products.

Thus, the inspection program generation device 100 generates a pre-inspection program that determines suitability for an inspection performed by the inspection unit 11 before the inspection unit 11 performs the inspection, and the pre-inspection program determines the suitability.

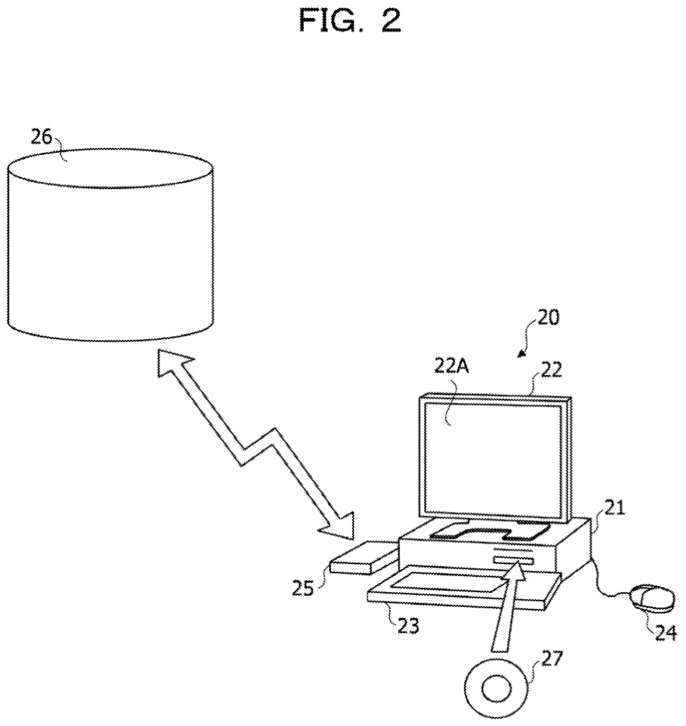

FIG. 2 is a perspective view of a computer system 20 that implements the inspection program generation device 100. The computer system 20 illustrated in FIG. 2 includes a main body 21, a display 22, a keyboard 23, a mouse 24, and a communication module 25.

The main body 21 includes a central processing unit (CPU), a hard disk drive (HDD), and a disk drive. The display 22 displays a processing result and the like on a screen 22A according to an instruction from the main body 21. The display 22 only needs to be, for example, a liquid crystal monitor. The keyboard 23 is an input unit for inputting various types of information to the computer system 20. The mouse 24 is an input unit that specifies an optional position on the screen 22A of the display 22. The communication module 25 communicates with the inspection device 10 by wireless communication.

An inspection program generation program that gives the computer system 20 a function as the inspection program generation device 100 is an example of the information processing program, and is stored in a portable recording medium such as a disk 27, or is downloaded from a recording medium 26 of another computer system by using a communication device such as the communication module 25 and is input to the computer system 20 to be compiled.

The inspection program generation program that gives the computer system 20 the function as the inspection program generation device 100 causes the computer system 20 to operate as the inspection program generation device 100. For example, the inspection program generation program may be stored in a computer-readable recording medium such as the disk 27. The computer-readable recording medium is not limited to the portable recording medium such as the disk 27, an IC card memory, a magnetic disk such as a floppy (registered trademark) disk, a magneto-optical disk, a CD-ROM, or a universal serial bus (USB) memory. The computer-readable recording media include various recording media accessible by the computer system connected via a communication device such as the communication module 25 or a LAN.

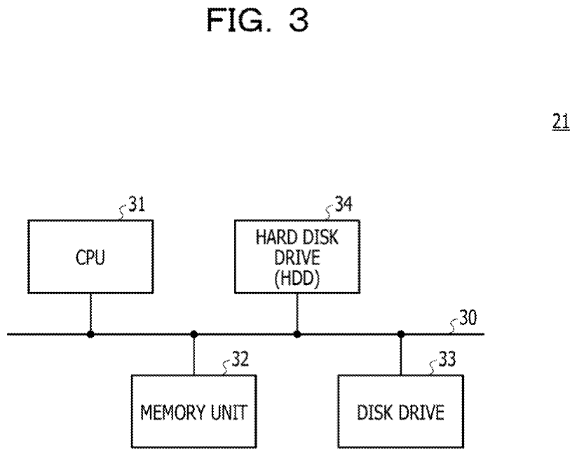

FIG. 3 is a block diagram for describing a configuration of main parts in the main body 21 of the computer system 20. The main body 21 includes a CPU 31, a memory unit 32 including a random access memory (RAM) or a read only memory (ROM), a disk drive 33 for the disk 27, and a hard disk drive (HDD) 34, which are connected by a bus 30.

Note that the computer system 20 is not limited to a computer system with the configuration illustrated in FIGS. 2 and 3, and various well-known components may be added or may be used as alternatives.

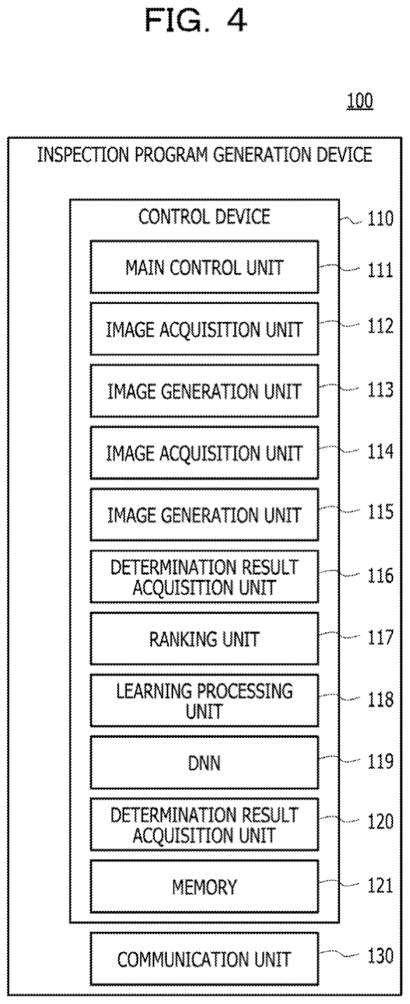

FIG. 4 is a diagram illustrating a configuration of the inspection program generation device 100. The inspection program generation device 100 includes a control device 110 and a communication unit 130.

The control device 110 includes a main control unit 111, an image acquisition unit 112, an image generation unit 113, an image acquisition unit 114, an image generation unit 115, a determination result acquisition unit 116, a ranking unit 117, a learning processing unit 118, a deep neural network (DNN) 119, a determination result acquisition unit 120, and a memory 121.

The main control unit 111, the image acquisition unit 112, the image generation unit 113, the image acquisition unit 114, the image generation unit 115, the determination result acquisition unit 116, the ranking unit 117, the learning processing unit 118, the DNN 119, and the determination result acquisition unit 120 indicate, as functional blocks, functions of a program executed by the control device 110. Furthermore, the memory 121 functionally represents the memory unit 32 and the HDD 34 (see FIG. 3) of the inspection program generation device 100.

Here, as a prerequisite, it is assumed that there is a plurality of determined pair images including acceptable images and unacceptable images, for which acceptance has been correctly determined by the inspection unit 11 of the inspection device 10 (see FIG. 1), and the plurality of determined pair images is stored in the memory 12 of the inspection device 10. The determined pair images are the pair images of the rank 1, and the acceptable images and the unacceptable images of the determined pair images are the acceptable images and the unacceptable images of the rank 1.

The main control unit 111 is a processing unit that supervises processing of the control device 110, and executes processing other than processing performed by the image acquisition unit 112, the image generation unit 113, the image acquisition unit 114, the image generation unit 115, the determination result acquisition unit 116, the ranking unit 117, the learning processing unit 118, the DNN 119, and the determination result acquisition unit 120.

The image acquisition unit 112 is an example of a first image acquisition unit, and acquires the plurality of determined pair images including the acceptable images and the unacceptable images, for which acceptance has been correctly determined by the inspection unit 11 of the inspection device 10 (see FIG. 1). The number of images (the number of pairs) of the plurality of determined pair images is, for example, 40 pairs (40 acceptable images and 40 unacceptable images).

The image generation unit 113 is an example of a second image generation unit, performs the pseudo image generation processing on the acceptable images and the unacceptable images of the plurality of determined pair images, and generates a plurality of pseudo pair images 1 including the acceptable images and the unacceptable images obtained by performing the pseudo image generation processing. The pseudo pair images 1 are examples of second pseudo pair images.

The pseudo image generation processing performed by the image generation unit 113 is an example of second pseudo image generation processing, and for example, two-step processing using a variational auto encoder (VAE) method and a generative adversarial network (GAN) is performed.

The image generation unit 113 generates the pseudo pair images 1 by performing image processing by the variational auto encoder method on the acceptable images and the unacceptable images of the determined pair images, and causing the GAN to learn the acceptable images and the unacceptable images obtained by the image processing and to perform image processing.

The pseudo image generation processing performed by the image generation unit 113 is very similar to the acceptable images and the unacceptable images of the determined pair images because there are relatively few changes to the acceptable images and the unacceptable images of the determined pair images, but is strictly different.

The pseudo image generation processing performed by the image generation unit 113 in this way is processing of generating pseudo images having a lower degree of image change to the determined pair images than pseudo image generation processing performed by the image generation unit 115 described later. Thus, the pseudo pair images 1 generated by the image generation unit 113 are images more similar to the determined pair images than pseudo pair images 2 generated by the image generation unit 115.

The pseudo pair images 1 generated by the image generation unit 113 are pair images of the rank 2, and the acceptable images and the unacceptable images of the pseudo pair images 1 are the acceptable images and the unacceptable images of the rank 2.

The image acquisition unit 114 is an example of a second image acquisition unit, causes the inspection unit 11 of the inspection device 10 to determine acceptance of the acceptable images and the unacceptable images of the pseudo pair images 1, and acquires the pseudo pair images 1 for which acceptance has been correctly determined. Note that acceptable images and unacceptable images of the pseudo pair images 1, for which acceptance has not been correctly determined by the inspection unit 11 of the inspection device 10, are discarded without being acquired by the image acquisition unit 114.

The image generation unit 115 is an example of a first image generation unit, and generates the pseudo pair images 2 including acceptable images and unacceptable images obtained by performing first pseudo image generation processing on the acceptable images and the unacceptable images of the plurality of determined pair images. The pseudo pair images 2 are examples of first pseudo pair images.

The pseudo image generation processing performed by the image generation unit 115 is an example of the first pseudo image generation processing, and as an example, two-step processing using the variational auto encoder method and the GAN is performed as in the image generation unit 113.

The image generation unit 115 generates the pseudo pair images 2 by performing image processing by the variational auto encoder method on the acceptable images and the unacceptable images of the determined pair images, and causing the GAN to learn the acceptable images and the unacceptable images obtained by the image processing and to perform image processing.

The pseudo image generation processing performed by the image generation unit 115 in this way is processing of generating pseudo images having a higher degree of image change to the determined pair images than the pseudo image generation processing performed by the image generation unit 113. Thus, the pseudo pair images 2 generated by the image generation unit 115 are images less similar (having a higher degree of change) to the determined pair images than the pseudo pair images 1 generated by the image generation unit 113. This is because, as an example, parameter values in the variational auto encoder method are different from those in the processing performed by the image generation unit 113.

Acceptance of the acceptable images and the unacceptable images of the pseudo pair images 2 generated by the image generation unit 115 is determined by the inspection unit 11 of the inspection device 10.

Furthermore, the pseudo pair images 2 including the acceptable images and the unacceptable images, for which acceptance has been determined by the inspection unit 11 of the inspection device 10, are ranked by the ranking unit 117 and classified into any of the ranks 3 to 6. The acceptable images and the unacceptable images included in the pseudo pair images 2 of the ranks 3 to 6 are the acceptable images and the unacceptable images of the ranks 3 to 6, respectively.

The determination result acquisition unit 116 is an example of a first determination result acquisition unit, and causes the inspection unit 11 of the inspection device 10 to determine acceptance of the acceptable images and the unacceptable images of the pseudo pair images 2 generated by the image generation unit 115, and acquires results of the acceptance determination.

The ranking unit 117 performs ranking according to correctness of determination on the basis of the determination results obtained by determining, by the inspection unit 11 of the inspection device 10, acceptance of the acceptable images and the unacceptable images of the pseudo pair images 2 generated by the image generation unit 115. The ranking is performed for each pair of the pseudo pair images 2 for which acceptance has been determined. The ranking unit 117 ranks the acceptable image and the unacceptable image of the pseudo pair images 2 into any of the ranks 3 to 6 according to the correctness of the determination.

Note that the pair images, the acceptable images, and the unacceptable images of the ranks 1 and 2 are handled as the ranks 1 and 2 without being ranked by the ranking unit 117.

In a case where both the acceptable image and the unacceptable image of the pseudo pair images 2 are correctly determined, the ranking unit 117 classifies the acceptable image and the unacceptable image of the pseudo pair images 2 into the rank 3 (third rank from the top).

Furthermore, in a case where the acceptable image of the pseudo pair images 2 is erroneously determined as an unacceptable image and the unacceptable image of the pseudo pair images 2 is correctly determined as an unacceptable image, the ranking unit 117 classifies the acceptable image and the unacceptable image of the pseudo pair images 2 into the rank 4 (fourth rank from the top).

Furthermore, in a case where the acceptable image of the pseudo pair images 2 is correctly determined as an acceptable image and the unacceptable image of the pseudo pair images 2 is erroneously determined as an acceptable image, the ranking unit 117 classifies the acceptable image and the unacceptable image of the pseudo pair images 2 into the rank 5 (fifth rank from the top).

Furthermore, in a case where the acceptable image of the pseudo pair images 2 is erroneously determined as an unacceptable image and the unacceptable image of the pseudo pair images 2 is erroneously determined as an acceptable image, the ranking unit 117 classifies the acceptable image and the unacceptable image of the pseudo pair images 2 into the rank 6 (lowest rank). The rank 6 is a case where both the acceptable image and the unacceptable image of the pseudo pair images 2 are erroneously determined.

Among the ranks 3 to 6, the ranks 4 to 6 are ranks in a case where acceptance of the acceptable image or the unacceptable image of the pseudo pair images 2 is erroneously determined by the inspection unit 11 of the inspection device 10.

The learning processing unit 118 optimizes parameters of the DNN 119 to improve determination accuracy of the DNN 119 by causing the DNN 119 to undergo machine learning using the determined pair images of the rank 1, the pseudo pair images 1 of the rank 2, and the pseudo pair images 2 of the ranks 3 to 6. The machine learning that the learning processing unit 118 causes the DNN 119 to undergo is an example of second machine learning.

The learning processing unit 118 uses a predetermined number of images of each rank when causing the DNN 119 to undergo the machine learning. The predetermined number may be different for each rank. The predetermined number of the pseudo pair images 1 of the rank 2 is an example of a second predetermined number, and the predetermined number of the pseudo pair images 2 of each rank of the ranks 3 to 6 is an example of a first predetermined number.

Furthermore, the predetermined number of the pseudo pair images 2 of the rank 6 is an example of a third predetermined number, and the predetermined number of the pseudo pair images 2 of the rank 4 or 5 is an example of a fourth predetermined number. The predetermined number of the pseudo pair images 2 of the rank 3 is an example of a fifth predetermined number.

The DNN 119 is a deep neural network (DNN). The DNN 119 implements a mathematical model represented by the pre-inspection program that determines, when an acceptable image and an unacceptable image of pair images are input, whether it is appropriate to cause the inspection unit 11 to determine acceptance of the acceptable image and the unacceptable image of the pair images. The pre-inspection program is an example of a second inspection program. The pre-inspection program is a program that preliminarily determines whether it is appropriate to cause the inspection unit 11 to determine acceptance of an acceptable image and an unacceptable image of unknown pair images. The unknown pair images are an image pair including an acceptable image and an unacceptable image for which acceptance determination has not been made by the inspection unit 11.

The DNN 119 undergoes machine learning using the determined pair images of the rank 1, the pseudo pair images 1 of the rank 2, and the pseudo pair images 2 of the ranks 3 to 6, which are input by the learning processing unit 118. As a result, the parameters of the DNN 119 are optimized, and by the pre-inspection program, the DNN 119 is brought into a state where the DNN 119 may determine suitability for an inspection performed by the inspection unit 11, with high accuracy of about 90%.

When the DNN 119 reads an acceptable image and an unacceptable image of unknown pair images (when an acceptable image and an unacceptable image of unknown pair images are input) in a state where the machine learning is completed and the pre-inspection program is optimized, the DNN 119 determines, with high accuracy of about 90%, whether the unknown pair images are pair images suitable for the inspection performed by the inspection unit 11 (whether the unknown pair images are appropriate pair images) or an unsuitable pair images (whether the unknown pair images are inappropriate pair images), and outputs a determination result.

The pair images appropriate for the inspection performed by the inspection unit 11 represent pair images for which the inspection unit 11 may make acceptable determination or unacceptable determination. Furthermore, the pair images inappropriate for the inspection performed by the inspection unit 11 represent pair images for which it is difficult for the inspection unit 11 to make acceptable determination or unacceptable determination.

Specifically, when the acceptable image and the unacceptable image of the unknown pair images are input, the DNN 119 determines whether the unknown pair images are pair images appropriate for the inspection performed by the inspection unit 11 by determining which of the ranks 1 to 6 the acceptable image and the unacceptable image of the unknown pair images correspond to.

Here, as an example, it is assumed that, when the input acceptable image and unacceptable image of the unknown pair images correspond to the ranks 1 to 5, the DNN 119 determines that the unknown pair images are pair images appropriate for the inspection performed by the inspection unit 11, and when the input acceptable image and unacceptable image of the unknown pair images correspond to the rank 6, the DNN 119 determines that the unknown pair images are pair images inappropriate for the inspection performed by the inspection unit 11.

Accuracy when the inspection unit 11 determines acceptance of the acceptable image and the unacceptable image of the unknown pair images is limited. Furthermore, it takes time for the inspection unit 11 to make preparations and the like from input of the unknown pair images to the acceptance determination. Due to such circumstances, the inspection program generation device 100 optimizes the parameters of the DNN 119 to improve efficiency of operation of the inspection device 10 and the inspection unit 11 by preliminarily determining whether the pair images are appropriate by the DNN 119. The inspection program generation device 100 generates the pre-inspection program in an optimized state by optimizing the parameters of the DNN 119.

The determination result acquisition unit 120 is an example of a second determination result acquisition unit, and acquires a determination result output by the DNN 119. More specifically, the determination result acquisition unit 120 acquires a determination result obtained by determining whether it is appropriate to cause the inspection unit 11 to determine acceptance of the acceptable image and the unacceptable image of the unknown pair images by the DNN 119 in which the pre-inspection program is generated.

The memory 121 stores data, a program, and the like necessary for the control device 110 to perform the processing described above. The program includes the inspection program generation program that gives the computer system 20 (see FIG. 2) the function as the inspection program generation device 100.

The communication unit 130 communicates with the inspection device 10 via the network 50. The communication unit 130 corresponds to the communication module 25 of FIG. 2.

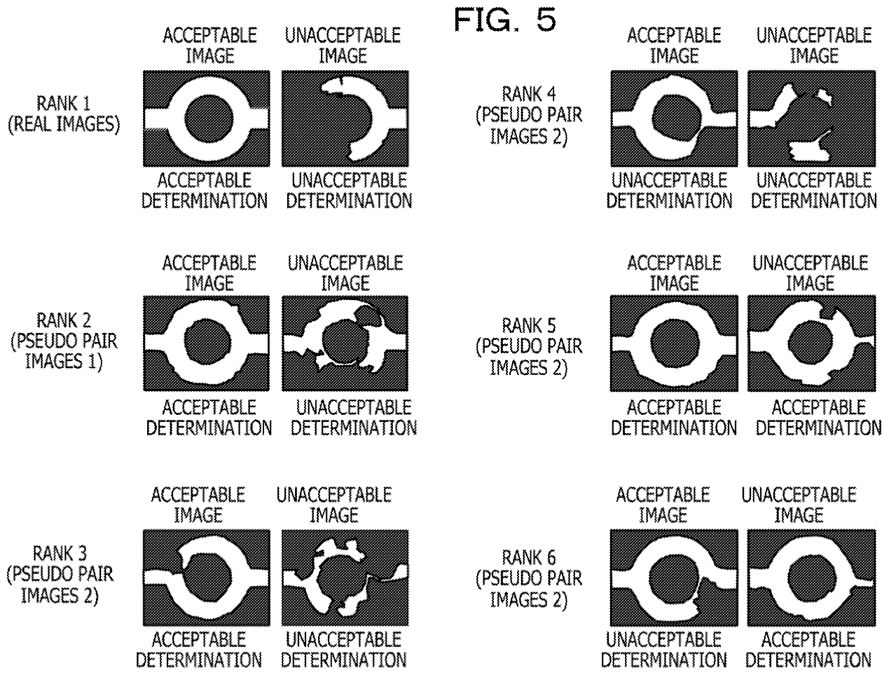

FIG. 5 is a diagram illustrating examples of pair images of the ranks 1 to 6. In the pair images of each rank, a left side is an acceptable image and a right side is an unacceptable image. Each of the pair images includes one acceptable image and one unacceptable image. Furthermore, in order to distinguish between an acceptable image and an unacceptable image, a flag only needs to be set for each image, as an example. A flag of an acceptable image only needs to be set to “1” and a flag of an unacceptable image only needs to be set to “0”.

The pair images of the ranks 1 to 6 illustrated in FIG. 5 are images obtained by binarizing and deforming actual pair images of the ranks 1 to 6. Thus, in FIG. 5, the pseudo pair images 1 of the rank 2 and the pseudo pair images of each rank of the ranks 3 to 6 have low degrees of similarity to the pair images of the rank 1 (determined pair images).

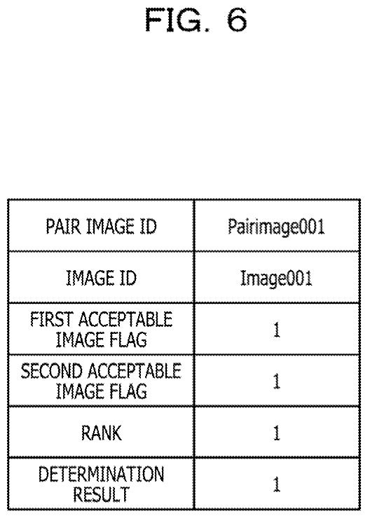

The pair images of the ranks 1 to 6 illustrated as examples are images of wiring patterns formed on a wiring substrate. Below each image, results of the acceptance determination by the inspection unit 11 of the inspection device 10 are indicated. Here, the determination result of the inspection unit 11 of the inspection device 10 is indicated as acceptable determination or unacceptable determination for each image. Data representing the result of the acceptance determination by the inspection unit 11 for each image is associated with an identifier (ID) of each image together with a flag for distinguishing an acceptable image and an unacceptable image. Such data for identifying an image will be described later with reference to FIG. 6.

As described above, the acceptable image and the unacceptable image of the rank 1 are the real images of the acceptable product and the unacceptable product, and are the acceptable image and the unacceptable image of the determined pair images. Thus, as illustrated in FIG. 5, the acceptable image of the rank 1 represents a beautiful wiring pattern, and the unacceptable image represents a wiring pattern in which about a left half is missing.

The inspection unit 11 of the inspection device 10 makes acceptable determination for the acceptable image of the rank 1, and makes unacceptable determination for the unacceptable image of the rank 1. For example, the inspection unit 11 of the inspection device 10 correctly determines both the acceptable image and the unacceptable image of the rank 1.

Furthermore, the acceptable image and the unacceptable image of the rank 2 illustrated in FIG. 5 are the acceptable image and the unacceptable image of the pseudo pair images 1 obtained by performing the pseudo image generation processing using the image processing by the variational auto encoder method and the GAN on the acceptable image and the unacceptable image of the rank 1, respectively.

To generate the acceptable image and the unacceptable image of the rank 2, the image generation unit 113 creates, by using the variational auto encoder method, a mixed acceptable image obtained by mixing the acceptable image and the unacceptable image of the rank 1 at a ratio of 100% and 0% and a mixed unacceptable image obtained by mixing the acceptable image and the unacceptable image of the rank 1 at a ratio of 0% and 100%. Thus, these mixed acceptable image and mixed unacceptable image are the acceptable image and the unacceptable image of the rank 1 (the acceptable image and the unacceptable image of the determined pair images) themselves, respectively.

Then, the image generation unit 113 causes the GAN to learn the mixed acceptable image obtained by the mixing at the ratio of 100% and 0% and the mixed unacceptable image obtained by the mixing at the ratio of 0% and 100% to perform the image processing, so that the acceptable image and the unacceptable image of the pseudo pair images 1 (the acceptable image and the unacceptable image of the rank 2) are generated.

By using a plurality of the acceptable images and the unacceptable images of the rank 1, it is possible to generate a plurality of the mixed acceptable images and the mixed unacceptable images. It is possible to obtain at least the same number of the mixed acceptable images and mixed unacceptable images as the acceptable images and the unacceptable images of the rank 1.

Then, by causing the GAN to learn the plurality of mixed acceptable images and mixed unacceptable images, it is possible to generate more acceptable images and unacceptable images of the pseudo pair images 1 (acceptable images and unacceptable images of the rank 2).

The acceptable images and the unacceptable images of the rank 2 generated in this way are images very similar to the acceptable images and the unacceptable images of the rank 1.

The determination results of the inspection unit 11 of the inspection device 10 for the acceptable image and the unacceptable image of the rank 2 are the acceptable determination and the unacceptable determination, respectively. For example, the inspection unit 11 of the inspection device 10 correctly determines both the acceptable image and the unacceptable image of the rank 2.

Furthermore, the acceptable images and the unacceptable images of the ranks 3 to 6 are the acceptable images and the unacceptable images of the pseudo pair images 1 obtained by performing the pseudo image generation processing using the image processing by the variational auto encoder method and the GAN on the acceptable images and the unacceptable images of the rank 1. The processing of generating the acceptable images and the unacceptable images of the ranks 3 to 6 is different from the processing of generating the acceptable image and the unacceptable image of the rank 2 in a mixing ratio of the acceptable image and the unacceptable image of the rank 1 in the variational auto encoder method. The mixing ratio is a parameter in the variational auto encoder method.

To generate the acceptable images and the unacceptable images of the ranks 3 to 6, the image generation unit 115 creates, by using the variational auto encoder method, a mixed acceptable image obtained by mixing the acceptable image and the unacceptable image of the rank 1 at a ratio of 80% and 20%, respectively, and a mixed unacceptable image obtained by mixing the acceptable image and the unacceptable image of the rank 1 at a ratio of 20% and 80%, respectively.

Then, the image generation unit 115 causes the GAN to learn the mixed acceptable image obtained by the mixing at the ratio of 80% and 20% and the mixed unacceptable image obtained by the mixing at the ratio of 20% and 80% to perform the image processing, so that the acceptable image and the unacceptable image of the pseudo pair images 2 (the acceptable image and the unacceptable image of any of the ranks 3 to 6) are generated.

By using a plurality of the acceptable images and the unacceptable images of the rank 1, it is possible to generate a plurality of the mixed acceptable images and the mixed unacceptable images. It is possible to obtain at least the same number of the mixed acceptable images and mixed unacceptable images as the acceptable images and the unacceptable images of the rank 1.

Then, by causing the GAN to learn the plurality of mixed acceptable images and mixed unacceptable images, it is possible to generate more acceptable images and unacceptable images of the pseudo pair images 2 (acceptable images and unacceptable images of any of the ranks 3 to 6).

The pseudo pair images 2 generated by the image generation unit 115 are classified into any of the ranks 3 to 6 by the ranking unit 117.

The determination results of the inspection unit 11 of the inspection device 10 for the acceptable image and the unacceptable image of the rank 3 illustrated in FIG. 5 are the acceptable determination and the unacceptable determination, respectively, and both are correctly determined. Although the acceptable image and the unacceptable image of the rank 3 are less similar to the acceptable image and the unacceptable image of the rank 1 than the acceptable image and the unacceptable image of the rank 2, an outline of a wiring pattern in the acceptable image is relatively clear, and the acceptable determination by the inspection unit 11 is correct. Furthermore, the unacceptable image has a missing wiring pattern, and the unacceptable determination by the inspection unit 11 is correct.

Furthermore, the determination results of the inspection unit 11 of the inspection device 10 for the acceptable image and the unacceptable image of the rank 4 illustrated in FIG. 5 are both unacceptable determination. For example, the inspection unit 11 erroneously determines the acceptable image as an unacceptable image, and correctly determines the unacceptable image as an unacceptable image.

Although the acceptable image and the unacceptable image of the rank 4 are less similar to the acceptable image and the unacceptable image of the rank 1 than the acceptable image and the unacceptable image of the rank 2, an outline of a wiring pattern in the acceptable image is relatively clear, and thus the unacceptable determination by the inspection unit 11 is incorrect. Furthermore, the unacceptable image has a missing wiring pattern, and the unacceptable determination by the inspection unit 11 is correct.

Making unacceptable determination for an acceptable image in this way is excessive determination in which unacceptable determination is excessively made. When the excessive determination occurs, an acceptable product may be treated as an unacceptable product and a yield may decrease. Thus, it is preferable that a probability that the excessive determination is made is low.

Furthermore, the determination results of the inspection unit 11 of the inspection device 10 for the acceptable image and the unacceptable image of the rank 5 illustrated in FIG. 5 are both acceptable determination. For example, the inspection unit 11 correctly determines the acceptable image as an acceptable image, and erroneously determines the unacceptable image as an acceptable image.

Although the acceptable image and the unacceptable image of the rank 5 are less similar to the acceptable image and the unacceptable image of the rank 1 than the acceptable image and the unacceptable image of the rank 2, an outline of a wiring pattern in the acceptable image is relatively clear, and thus the acceptable determination by the inspection unit 11 is correct. Furthermore, since a right end of a wiring pattern in the unacceptable image is thinner than the reference, the acceptable determination by the inspection unit 11 is incorrect.

Making acceptable determination for an unacceptable image in this way is overlooking determination in which the unacceptable image is overlooked. When the overlooking determination occurs, an unacceptable product may be shipped. Thus, it is preferable that a probability that the overlooking determination is made is low.

The determination results of the inspection unit 11 of the inspection device 10 for the acceptable image and the unacceptable image of the rank 6 illustrated in FIG. 5 are the unacceptable determination and the acceptable determination, respectively, and both are erroneously determined. Although the acceptable image and the unacceptable image of the rank 6 are less similar to the acceptable image and the unacceptable image of the rank 1 than the acceptable image and the unacceptable image of the rank 2, an outline of a wiring pattern in the acceptable image is relatively clear, and thus the unacceptable determination is incorrect. Furthermore, since a right end of a wiring pattern in the unacceptable image is thinner than the reference, the acceptable determination by the inspection unit 11 is incorrect. For the acceptable image and the unacceptable image of the rank 6, both the excessive determination in which the unacceptable determination is made for the acceptable image and the overlooking determination in which the acceptable determination is made for the unacceptable image.

FIG. 6 is a diagram illustrating image identification data handled by the inspection program generation device 100. The image identification data indicated in FIG. 6 is assigned to each acceptable image and unacceptable image, and is common to the acceptable images and the unacceptable images of the determined pair images, the pseudo pair images 1, the pseudo pair images 2, and the unknown pair images. The image identification data is stored in the memory 121.

The image identification data includes items of a pair image identifier (ID), an image ID, a first acceptable image flag, a second acceptable image flag, a rank, and a determination result.

The pair image ID is an ID as pair images, and is assigned to the determined pair images, the pseudo pair images 1, the pseudo pair images 2, and the unknown pair images. The pair image IDs of the determined pair images, the pseudo pair images 1, the pseudo pair images 2, and the unknown pair images may be mutually identified, and it is possible to identify, by the pair image ID, whether pair images are the determined pair images, the pseudo pair images 1, the pseudo pair images 2, or the unknown pair images.

The image ID is an ID assigned to each acceptable image and unacceptable image included in each pair images. Thus, each of an acceptable image and an unacceptable image included in one pair images has the image identification data indicated in FIG. 6.

The first acceptable image flag is set to “1” in the case of an acceptable image of a mass-produced product that has passed an inspection performed by a human, is set to “0” in the case of an unacceptable image of a mass-produced product that has not passed an inspection performed by a human, and data is not set (“-” is set) in a case where an inspection by a human is not performed. The first acceptable image flag is set to “1” and “0” for the acceptable image and the unacceptable image included in the determined pair images of the rank 1, respectively, and no data is set (“-” is set) for the acceptable images and the unacceptable images included in the pseudo pair images 1 of the rank 2 and the pseudo pair images 2 of the ranks 3 to 6.

The second acceptable image flag is set to “1” in the case of an acceptable image of a mass-produced product that has passed an inspection performed by the inspection unit 11, is set to “0” in the case of an unacceptable image of a mass-produced product that has not passed an inspection performed by the inspection unit 11, and data is not set (“-” is set) in a case where an inspection by the inspection unit 11 is not performed. The second acceptable image flag is set to “1” or “0” for each of the acceptable images and the unacceptable images included in the pair images of the ranks 1 to 6.

The rank represents the ranks 1 to 6. The determined pair images are set to the rank 1, the pseudo pair images 1 are set to the rank 2, and the pseudo pair images 2 are set to the rank (any of the ranks 3 to 6) classified by the ranking unit 117.

The determination result represents results of the acceptance determination by the inspection unit 11 for the acceptable images and the unacceptable images of the determined pair images, the pseudo pair images 1, and the pseudo pair images 2, and “1” is set in the case of the acceptable determination and “0” is set in the case of the unacceptable determination.

The image identification data indicated in FIG. 6 is, as an example, the image identification data for the acceptable image of the determined pair images. Note that, in the case of the unknown pair images, only the pair image ID and the image ID are included.

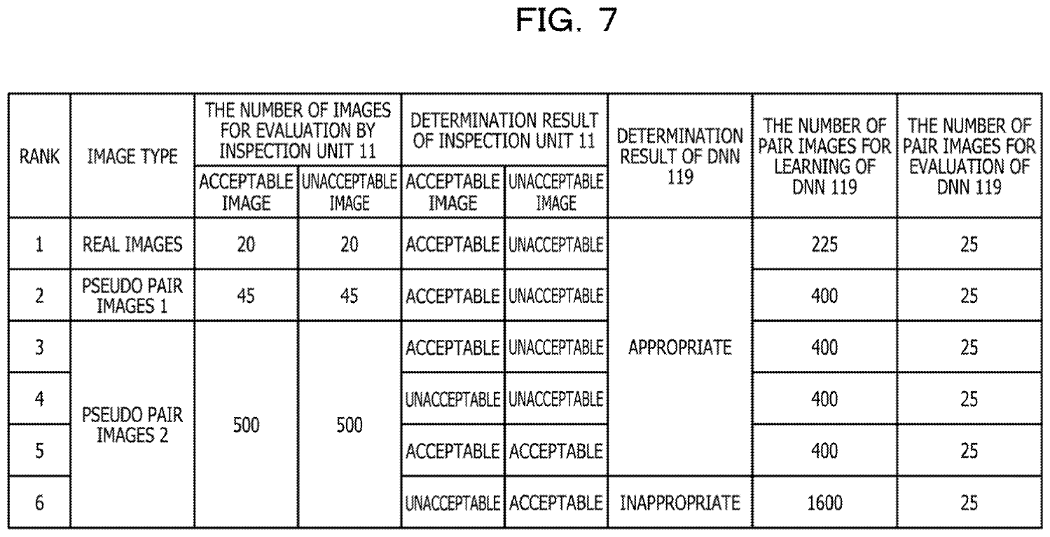

FIG. 7 is a diagram illustrating conditions relating to image evaluation by the inspection unit 11 and images for learning and for evaluation of the DNN 119. FIG. 7 indicates, for the acceptable images and the unacceptable images of the ranks 1 to 6, an image type, the number of images for evaluation by the inspection unit 11, a determination result of the inspection unit 11, a determination result of the DNN 119, the number of pair images for learning of the DNN 119, and the number of pair images for evaluation of the DNN 119.

The image type represents whether the acceptable image and the unacceptable image are the real images, the pseudo pair images 1, or the pseudo pair images 2. The number of images for evaluation by the inspection unit 11 represents the number of images of an acceptable image and an unacceptable image when the pair images of each rank are input to the inspection unit 11 and evaluation for determining acceptance is performed. The determination results of the inspection unit 11 represent results of evaluation (acceptance determination) by the inspection unit 11.

The determination result of the DNN 119 indicates a determination result output by the DNN 119 in a case where the acceptable image and the unacceptable image of the unknown pair images are input to the DNN 119. As described above, here, as an example, the DNN 119 is set to make determination of appropriate in a case where the acceptable image and the unacceptable image of the unknown pair images correspond to the ranks 1 to 5, and to make determination of inappropriate in a case where the acceptable image and the unacceptable image of the unknown pair images correspond to the rank 6. Note that the classification method is not limited to such a method, and the ranks 5 and 6 may be determined to be inappropriate, the ranks 4 to 6 may be determined to be inappropriate, the ranks 4 and 6 may be determined to be inappropriate, or the ranks 3 to 6 may be determined to be inappropriate.

Furthermore, although a mode in which output of the DNN 119 is in two stages (appropriate or inappropriate) will be described here, the output may be in three stages or more, or in six stages.

The number of pair images for learning of the DNN 119 represents the number of pair images of each rank when the DNN 119 is caused to undergo machine learning. The number of pair images for evaluation of the DNN 119 represents the number of pair images of each rank to be input when the pre-inspection program is evaluated after the end of the learning of the DNN 119.

The image type of the acceptable image and the unacceptable image of the rank 1 is the real images, and the number of images of each of the acceptable image and the unacceptable image when the inspection unit 11 performs evaluation by acceptance determination is 20, as an example. Furthermore, the results of the acceptance determination by the inspection unit 11 for the acceptable image and the unacceptable image of the rank 1 are acceptable determination and unacceptable determination, respectively. The determination result of the DNN 119 is appropriate, and the numbers of pair images for learning and for evaluation of the DNN 119 are 225 pairs and 25 pairs, respectively.

The image type of the acceptable image and the unacceptable image of the rank 2 is the pseudo pair images 1, and the number of images of both the acceptable image and the unacceptable image when the inspection unit 11 performs evaluation by acceptance determination is 45, as an example. Furthermore, the results of the acceptance determination by the inspection unit 11 for the acceptable image and the unacceptable image of the rank 2 are acceptable determination and unacceptable determination, respectively.

Furthermore, the determination result of the DNN 119 is appropriate, and the numbers of pair images for learning and for evaluation of the DNN 119 are 400 pairs and 25 pairs, respectively.

The image type of the acceptable image and the unacceptable image of the rank 3 is the pseudo pair images 2, and the results of the acceptance determination by the inspection unit 11 for the acceptable image and the unacceptable image of the rank 3 are acceptable determination and unacceptable determination, respectively. Furthermore, the determination result of the DNN 119 is appropriate, and the numbers of pair images for learning and for evaluation of the DNN 119 are 400 pairs and 25 pairs, respectively.

Furthermore, the number of images of both the acceptable images and the unacceptable images of the pseudo pair images 2 of the ranks 3 to 6 when the inspection unit 11 performs evaluation by acceptance determination is 500. This means that, in a state where classification into the ranks 3 to 6 is not performed, the number of images of both the acceptable image and the unacceptable image of the pseudo pair images 2 which may correspond to any of the ranks 3 to 6 for which the inspection unit 11 performs evaluation by acceptance determination is 500.

The pseudo pair images 2 of 500 pairs are the pseudo pair images 2 used to obtain the pseudo pair images 2 of the ranks 3 to 6 for learning and for evaluation of the DNN 119.

The image type of the acceptable image and the unacceptable image of the rank 4 is the pseudo pair images 2, and the results of the acceptance determination of the inspection unit 11 for both the acceptable image and the unacceptable image of the rank 4 are unacceptable determination. Furthermore, the determination result of the DNN 119 is appropriate, and the numbers of pair images for learning and for evaluation of the DNN 119 are 400 pairs and 25 pairs, respectively.

The image type of the acceptable image and the unacceptable image of the rank 5 is the pseudo pair images 2, and the results of the acceptance determination of the inspection unit 11 for both the acceptable image and the unacceptable image of the rank 5 are acceptable determination. Furthermore, the determination result of the DNN 119 is appropriate, and the numbers of pair images for learning and for evaluation of the DNN 119 are 400 pairs and 25 pairs, respectively.

The image type of the acceptable image and the unacceptable image of the rank 6 is the pseudo pair images 2, and the results of the acceptance determination of the inspection unit 11 for the acceptable image and the unacceptable image of the rank 6 are unacceptable determination and acceptable determination, respectively. Furthermore, the determination result of the DNN 119 is inappropriate, and the numbers of pair images for learning and for evaluation of the DNN 119 are 1600 pairs and 25 pairs, respectively.

As described above, the number of images of the acceptable image and the unacceptable image when the inspection unit 11 performs evaluation by acceptance determination is the smallest for the acceptable image and the unacceptable image of the rank 1. This is because, since the acceptable image and the unacceptable image of the rank 1 are the real images and it is highly likely that the acceptance determination of the inspection unit 11 is correctly made, 20 images are sufficient to obtain each of the acceptable image and the unacceptable image of the rank 1 for learning and for evaluation of the DNN 119.

Furthermore, the number of images of the acceptable image and the unacceptable image when the inspection unit 11 performs evaluation by acceptance determination is set to 45 for each of the acceptable image and the unacceptable image of the rank 2. This is because, since the acceptable image and the unacceptable image of the rank 2 are very similar to the acceptable image and the unacceptable image of the rank 1 and it is likely that the acceptance determination of the inspection unit 11 is correctly made, about twice the number of images of the rank 1 is sufficient to obtain the acceptable image and the unacceptable image of the rank 2 for learning and for evaluation of the DNN 119.

Furthermore, for the number of images of the acceptable image and the unacceptable image when the inspection unit 11 performs evaluation by acceptance determination, the number of images of the acceptable image and the unacceptable image of the pseudo pair images 2 which may correspond to any of the ranks 3 to 6 is the largest. This is because, for learning and evaluation of the DNN 119, a predetermined number or more of the acceptable images and the unacceptable images of the pseudo pair images 2 are used for each of the ranks 3 to 6, so that it is preferable that the number of images is relatively large. Thus, the number of images is set to 500.

Furthermore, the number of pair images for learning of the DNN 119 for the acceptable image and the unacceptable image of the rank 1 is set to be the smallest. This is because, since the acceptable image and the unacceptable image of the rank 1 are the real images, a relatively small number of images is sufficient.

Furthermore, the number of pair images for learning of the DNN 119 for the acceptable images and the unacceptable images of the ranks 2 to 5 is set to be the second smallest. Since the acceptable images and the unacceptable images of the ranks 2 to 5 include changes to the acceptable image and the unacceptable image of the rank 1, the number of images for learning is increased more than that of the rank 1 in order to secure the sufficient number of images for the DNN 119 to learn the acceptable images and the unacceptable images of the ranks 2 to 5.

Furthermore, the number of pair images for learning of the DNN 119 for the acceptable image and the unacceptable image of the rank 6 is set to be the largest. Since the rank 6 is a case where both the acceptable image and the unacceptable image are erroneously determined, the number of images for learning is increased more than that of the ranks 2 to 5 in order to secure the sufficient number of images for the DNN 119 to learn the acceptable image and the unacceptable image of the rank 6.

Furthermore, the number of pair images for evaluation of the DNN 119 for the acceptable images and the unacceptable images of the ranks 1 to 6 is all the same. This is because the same number of the acceptable images and the unacceptable images of the ranks 1 to 6 are evaluated by the DNN 119.

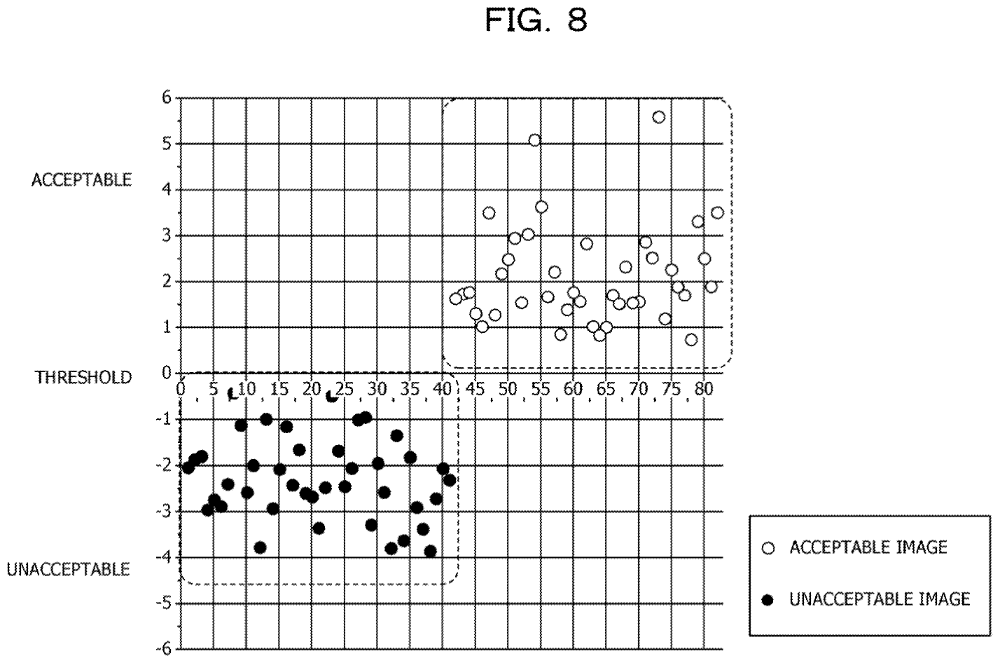

FIG. 8 is a diagram illustrating distribution of determination results of the acceptable images and the unacceptable images of the pseudo pair images 1 by the inspection unit 11. The determination results indicated in FIG. 8 are results of actual determination by the inspection unit 11.

In FIG. 8, a horizontal axis is a sample number, and the determination results of the acceptable images are indicated by white circle (◯) markers, and the determination results of the unacceptable images are indicated by black circle (●) markers. The sample numbers of about 40 or less are the determination results of the unacceptable images, and the sample numbers of about 40 or more are the determination results of the acceptable images. Furthermore, a vertical axis is a determination value by the inspection unit 11, and the determination value equal to or greater than a threshold is acceptable and the determination value less than the threshold is unacceptable.

As indicated in FIG. 8, the inspection unit 11 determines all the acceptable images as acceptable, and all the unacceptable images as unacceptable. In this way, accuracy with which the inspection unit 11 determines the acceptable images and the unacceptable images of the pseudo pair images 1 is very high.

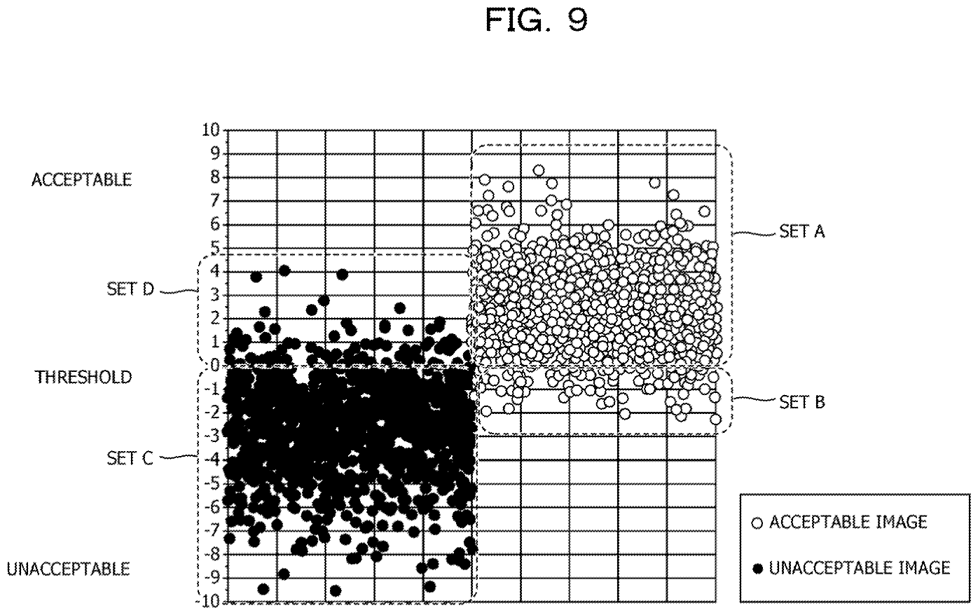

FIG. 9 is a diagram illustrating distribution of determination results of the acceptable images and the unacceptable images of the pseudo pair images 2 by the inspection unit 11. Meanings of a horizontal axis, a vertical axis, and markers are similar to those in FIG. 8, and the determination results indicated in FIG. 9 are results of actual determination by the inspection unit 11. FIG. 9 indicates the determination results for more samples than in FIG. 8.

As indicated in FIG. 9, sets A to D are obtained. The set A is a set of samples for which the inspection unit 11 has correctly determined that the acceptable images are acceptable. The set B is a set of excessive determination samples for which the inspection unit 11 has erroneously determined that the acceptable images are unacceptable. The set C is a set of samples for which the inspection unit 11 has correctly determined that the unacceptable images are unacceptable. The set D is a set of overlooking determination samples for which the inspection unit 11 has erroneously determined that the unacceptable images are acceptable.

The sets A and C are sets of samples for which the inspection unit 11 has correctly determined each of the acceptable images and the unacceptable images of the pseudo pair images 2 of the ranks 3 to 6, and the sets B and D are sets of samples for which the inspection unit 11 has erroneously determined each of the acceptable images and the unacceptable images of the pseudo pair images 2 of the ranks 3 to 6. Compared with the sets A and C, the number of samples of the sets B and D for which erroneous determination has been made is small.

Among the sets A to D, the sets B and D are the sets of the excessive determination samples and the overlooking determination samples that are difficult to obtain from the acceptable images and the unacceptable images of the real images. When such determination results belonging to the sets B and D are used for machine learning of the DNN 119, erroneous determination may be reduced and determination accuracy of the DNN 119 may be improved.

Thus, the inspection program generation device 100 generates the pseudo pair images 2 of the ranks 3 to 6 on the basis of the determined pair images (rank 1), and inputs the pseudo pair images 2 of the ranks 3 to 6 as teacher data to the DNN 119 to cause the DNN 119 to undergo machine learning.

Furthermore, the inspection program generation device 100 further inputs the pseudo pair images 2 of the rank 2 as teacher data to the DNN 119 to cause the DNN 119 to undergo machine learning. The pseudo pair images 2 of the rank 2 are used mainly to increase the number of samples.

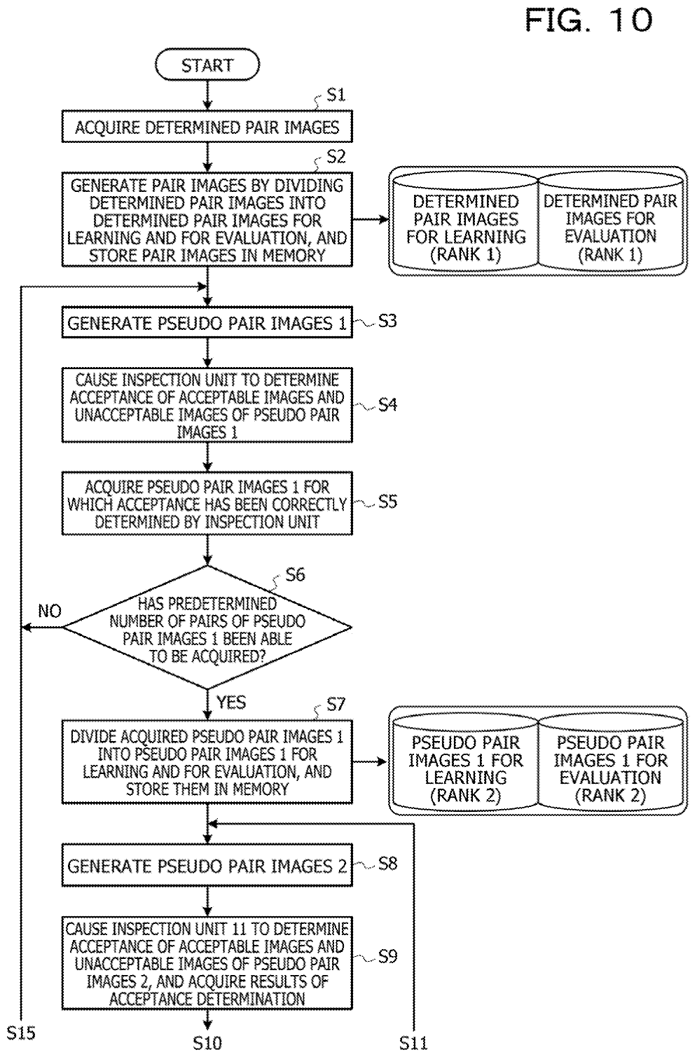

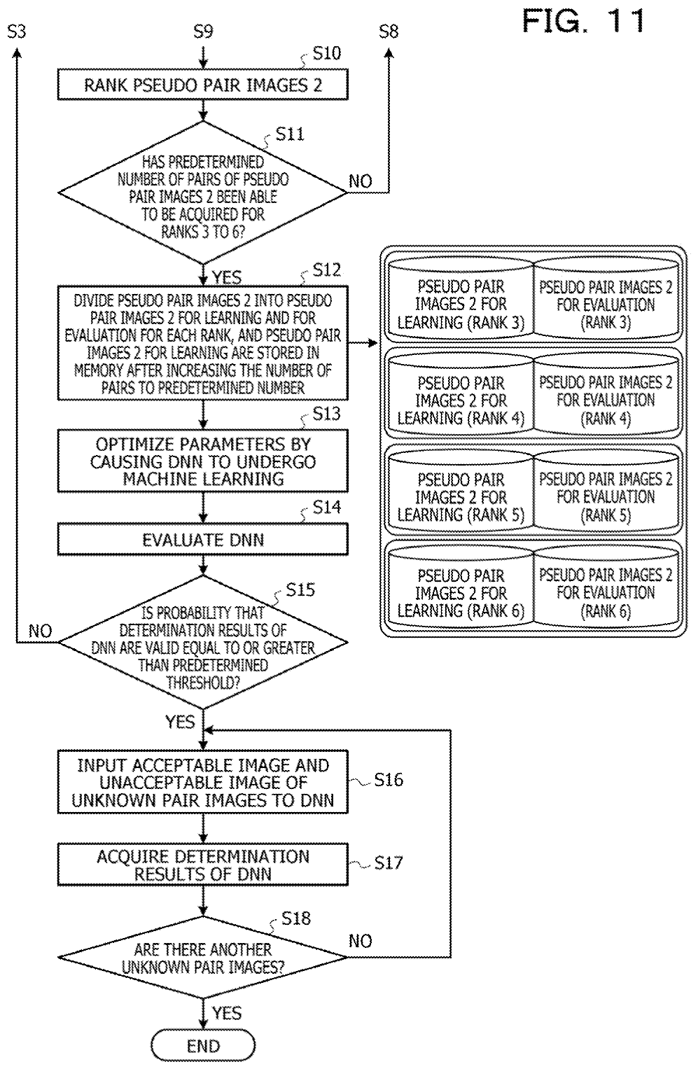

FIGS. 10 and 11 are diagrams illustrating a flowchart representing processing executed by the control device 110 of the inspection program generation device 100.

As a prerequisite of the processing, it is assumed that a plurality of determined pair images including acceptable images and unacceptable images, for which acceptance has been correctly determined by the inspection unit 11 of the inspection device 10 (see FIG. 1), is stored in the memory 12. Furthermore, it is assumed that one or a plurality of unknown pair images for which whether pair images are appropriate pair images or inappropriate pair images is to be determined at the end of machine learning of the DNN 119 is stored in the memory 121.

The image acquisition unit 112 acquires the determined pair images from the inspection device 10 (Step S1). The main control unit 111 receives, via the network 50, the determined pair images from the inspection device 10 via the communication unit 130, and the image acquisition unit 112 acquires the received determined pair images.

The main control unit 111 generates pair images by dividing the determined pair images acquired by the image acquisition unit 112 into determined pair images for learning and determined pair images for evaluation at a predetermined distribution ratio, and stores the pair images in the memory 121 (Step S2).

For example, in a case where 20 pairs of determined pair images are acquired from the inspection device 10, the predetermined distribution ratio is 15 pairs and 5 pairs, as an example. The main control unit 111 creates 225 pairs (225 pairs obtained by combining 15 images×15 images) of determined pair images for learning from 15 acceptable images and 15 unacceptable images included in 15 pairs of determined pair images, and at the same time, creates 25 pairs (25 pairs obtained by combining 5 images×5 images) of determined pair images for evaluation from 5 acceptable images and 5 unacceptable images included in 5 pairs of determined pair images, and stores them in the memory 121.

The image generation unit 113 performs the pseudo image generation processing on the acceptable images and the unacceptable images of the plurality of determined pair images, and generates a plurality of pseudo pair images 1 including the acceptable images and the unacceptable images obtained by performing the pseudo image generation processing (Step S3). The number of pairs of the plurality of determined pair images is 20 pairs, as an example.

For example, by performing the pseudo image generation processing on the plurality of determined pair images, the image generation unit 113 generates 45 pairs of the pseudo pair images 1 including 45 acceptable images and 45 unacceptable images obtained by performing the pseudo image generation processing.

The image acquisition unit 114 causes the inspection unit 11 of the inspection device 10 to determine acceptance of the acceptable images and the unacceptable images of the 45 pairs of the pseudo pair images 1 (Step S4).

The image acquisition unit 114 causes the main control unit 111 to transmit the plurality of pseudo pair images 1 to the inspection device 10 via the communication unit 130, and causes the inspection unit 11 of the inspection device 10 to determine acceptance of the acceptable images and the unacceptable images of the pseudo pair images 1.

The image acquisition unit 114 acquires the pseudo pair images 1 for which acceptance has been correctly determined by the inspection unit 11 (Step S5). More specifically, the image acquisition unit 114 causes the main control unit 111 to receive the plurality of pseudo pair images 1 including the acceptable images and the unacceptable images for which acceptance has been determined by the inspection device 10 and results of the acceptance determination. The results of the acceptance determination are registered in the image identification data (see FIG. 6).

Then, among the plurality of received pseudo pair images 1, the image acquisition unit 114 acquires the pseudo pair images 1 including the acceptable images and the unacceptable images for which acceptance has been correctly determined by the inspection device 10.

Which of the two images included in the pseudo pair images 1 is an acceptable image may be determined by a value of the second acceptable image flag of the image identification data. Thus, when the images included in the pseudo pair images 1 are collated with and match the results of the acceptance determination, correct determination is made, and when the images included in the pseudo pair images 1 do not match the results of the acceptance determination, erroneous determination is made.

Note that, since the pseudo pair images 1 are very similar to the acceptable images and the unacceptable images of the determined pair images, it is assumed here acceptance of all the acceptable images and the unacceptable images of the pseudo pair images 1 are correctly determined.

In this way, when the pairs of the acceptable images and the unacceptable images for which the acceptable images and the unacceptable images included in the pseudo pair images 1 and the results of the acceptance determination are collated and match are acquired, the image acquisition unit 114 may acquire the pseudo pair images 1 for which acceptance has been correctly determined by the inspection unit 11 of the inspection device 10.

The main control unit 111 determines whether a predetermined number of pairs of the pseudo pair images 1 has been able to be acquired (Step S6). The predetermined number of pairs of the pseudo pair images 1 includes the acceptable images and unacceptable images of the same number as those of the predetermined number of pairs. The number of the acceptable images and unacceptable images included in the predetermined number of pairs of the pseudo pair images 1 is an example of the second predetermined number.

When the main control unit 111 determines in Step S6 that the predetermined number of pairs of the pseudo pair images 1 has been able to be acquired (S6: YES), the main control unit 111 divides the pseudo pair images 1 acquired by the image acquisition unit 114 into pseudo pair images 1 for learning and pseudo pair images 1 for evaluation at a predetermined distribution ratio, and stores them in the memory 121 (Step S7).

For example, in a case where 45 pairs of the pseudo pair images 1 are acquired by the image acquisition unit 114, the predetermined distribution ratio is 20 pairs and 25 pairs, as an example. The main control unit 111 creates 400 pairs (400 pairs obtained by combining 20 images×20 images) of the pseudo pair images 1 for learning from 20 acceptable images and 20 unacceptable images included in 20 pairs of the pseudo pair images 1, and store them in the memory 121. Furthermore, the main control unit 111 stores 25 pairs of the pseudo pair images 1 as 25 pairs of the pseudo pair images 1 for evaluation in the memory 121.

Note that, when the main control unit 111 determines in Step S6 that the predetermined number of pairs of the pseudo pair images 1 has not been able to be acquired (S6: NO), the main control unit 111 returns the flow to Step S3.

The image generation unit 115 generates pseudo pair images 2 including acceptable images and unacceptable images obtained by performing the pseudo image generation processing on the acceptable images and the unacceptable images of the plurality of determined pair images (Step S8). Here, as an example, 500 pairs of the pseudo pair images 2 including 500 acceptable images and 500 unacceptable images are generated.

The determination result acquisition unit 116 causes the inspection unit 11 of the inspection device 10 to determine acceptance of the acceptable images and the unacceptable images of the pseudo pair images 2 generated in Step S8, and acquires results of the acceptance determination (Step S9). The results of the acceptance determination are registered in the image identification data (see FIG. 6).

The ranking unit 117 ranks the pseudo pair images 2 generated in Step S8 on the basis of correctness of the determination results acquired in Step S9 (Step S10). As a result, the pseudo pair images 2 are ranked as any of the ranks 3 to 6. The ranks are registered in the image identification data (see FIG. 6).

The main control unit 111 determines, for each of the ranks 3 to 6, whether a predetermined number of pairs of the pseudo pair images 2 has been able to be acquired (Step S11). There are 45 pairs for the ranks 3 to 5 and 65 pairs for the rank 6.

When the main control unit 111 determines in Step S11 that the predetermined number of pairs of the pseudo pair images 2 has been able to be acquired for each rank (S11: YES), the main control unit 111 performs the following processing in Step S12 (Step S12).

In Step S12, the main control unit 111 divides the pseudo pair images 2 ranked by the ranking unit 117 into pseudo pair images 2 for learning and pseudo pair images 2 for evaluation at a predetermined distribution ratio for each rank, and the pseudo pair images 2 for learning are stored in the memory 121 after increasing the number of pairs to a predetermined number by combining the acceptable images and the unacceptable images included in the pseudo pair images 2. The pseudo pair images 2 for evaluation are stored in the memory 121 as they are.

For example, for the ranks 3 to 5, 45 pairs of the pseudo pair images 2 are distributed to 20 pairs for learning and 25 pairs for evaluation according to a predetermined distribution ratio. Furthermore, 400 pairs (400 pairs obtained by combining 20 images×20 images) of the pseudo pair images 2 for learning are created from 20 acceptable images and 20 unacceptable images included in the 20 pairs of the pseudo pair images 2 for learning, and are stored in the memory 121. The 25 pairs of the pseudo pair images 2 for evaluation are stored in the memory 121 as they are.

Furthermore, for the rank 6, 65 pairs of the pseudo pair images 2 are distributed to 40 pairs for learning and 25 pairs for evaluation according to a predetermined distribution ratio. Furthermore, 1600 pairs (1600 pairs obtained by combining 40 images×40 images) of the pseudo pair images 2 for learning are created from 40 acceptable images and 40 unacceptable images included in the 40 pairs of the pseudo pair images 2 for learning, and are stored in the memory 121. The 25 pairs of the pseudo pair images 2 for evaluation are stored in the memory 121 as they are.

Note that, when the main control unit 111 determines in Step S11 that the predetermined number of pairs of the pseudo pair images 2 has not been able to be acquired for each rank (S11: NO), the main control unit 111 returns the flow to Step S8. As a result, new 500 pairs of the pseudo pair images 2 are generated in Step S8.

It is determined in Step S11 that the predetermined number of pairs of the pseudo pair images 2 has not been able to be acquired in a case where, for example, the pseudo pair images 2 of any of the ranks 3 to 6 have less than the predetermined number of pairs.

Next, the learning processing unit 118 optimizes parameters of the DNN 119 by reading, from the memory 121, the determined pair images for learning of the rank 1, the pseudo pair images 1 for learning of the rank 2, and the pseudo pair images 2 for learning of the ranks 3 to 6, input them to the DNN 119, and causing the DNN 119 to undergo machine learning (Step S13). This processing improves determination accuracy of the pre-inspection program.

Next, the learning processing unit 118 evaluates the DNN 119 by reading, from the memory 121, the determined pair images for evaluation of the rank 1, the pseudo pair images 1 for evaluation of the rank 2, and the pseudo pair images 2 for evaluation of the ranks 3 to 6, input them to the DNN 119, and obtaining determination results (Step S14). When the pair images of the ranks 1 to 5 are input and the DNN 119 determines that the pair images of the ranks 1 to 5 are appropriate, the determination results of the DNN 119 are valid. Furthermore, when the pair images of the rank 6 are input and the DNN 119 determines that the pair images of the rank 6 are not appropriate, the determination results of the DNN 119 are valid. In other cases, the determination results of the DNN 119 are not valid.

The learning processing unit 118 determines whether a probability that the determination results of the DNN 119 are valid is equal to or greater than a predetermined threshold (Step S15). The predetermined threshold is about 90%, as an example.

When the learning processing unit 118 determines that the probability that the determination results of the DNN 119 are valid is not equal to or greater than the predetermined threshold (S15: NO), the main control unit 111 returns the flow to Step S3.

Furthermore, when the learning processing unit 118 determines that the probability that the determination results of the DNN 119 are valid is equal to or greater than the predetermined threshold (S15: YES), the learning processing unit 118 inputs an acceptable image and an unacceptable image of predetermined unknown pair images to the DNN 119 (Step S16). Note that, at this time, when it is necessary to convert a format of the images to be input to the DNN 119, the acceptable image and the unacceptable image of the predetermined unknown pair images only need to be input to the DNN 119 after converting the format to a format for the DNN 119.

The determination result acquisition unit 120 acquires the determination results of the DNN 119 (Step S17). The determination result represents whether the unknown pair images are appropriate pair images or inappropriate pair images for an inspection by the inspection unit 11.

The main control unit 111 determines whether there are another unknown pair images to be input to the DNN 119 (Step S18).

When the main control unit 111 determines that there are another unknown pair images (S18: YES), the main control unit 111 returns the flow to step S16.

When the main control unit 111 determines that there are not another unknown pair images (S18: NO), the main control unit 111 ends a series of the processing (end).

As described above, the inspection program generation device 100 generates, from the determined pair images (rank 1) including the acceptable images and the unacceptable images of the real images, the pseudo pair images 1 of the rank 2 and the pseudo pair images 2 of the ranks 3 to 6. The pseudo pair images 1 of the rank 2 and the pseudo pair images 2 of the ranks 3 to 6 are generated by performing the pseudo image generation processing on the determined pair images, and a degree of change from the determined pair images is larger in the pseudo pair images 2 of the ranks 3 to 6 than in the pseudo pair images 1 of the rank 2.

A large number of such pseudo pair images 1 of the rank 2 and pseudo pair images 2 of the ranks 3 to 6 may be generated by the pseudo image generation processing. Furthermore, the image identification data (see FIG. 6) registers determination results representing acceptance determined by the inspection unit 11 for the acceptable images and the unacceptable images of the pseudo pair images 1 of the rank 2 and the pseudo pair images 2 of the ranks 3 to 6.

Therefore, the pseudo pair images 1 of the rank 2 and the pseudo pair images 2 of the ranks 3 to 6 may be used as teacher data for causing the DNN 119 to learn, by machine learning, a method of determining which of the ranks 1 to 6 an unknown acceptable image and unacceptable image for a predetermined mass-produced product correspond.

Then, by inputting an unknown acceptable image and unacceptable image to the DNN 119, the DNN 119 may determine whether it is appropriate to cause the inspection unit 11 to determine acceptance of the acceptable image and the unacceptable image of the unknown pair images. The DNN 119 determines that the unknown acceptable image and unacceptable image are appropriate when it is determined that the unknown acceptable image and unacceptable image correspond to the ranks 1 to 5, and determines that the unknown acceptable image and unacceptable image are inappropriate when it is determined that the unknown acceptable image and unacceptable image correspond to the rank 6.

Therefore, it is possible to provide the inspection program generation device 100 (information processing apparatus), the information processing program, and the information processing method that are capable of obtaining the DNN 119 (pre-inspection program) that may determine whether it is appropriate to cause the inspection unit 11 to determine acceptance of the acceptable image and the unacceptable image of the unknown pair images.

Furthermore, since the inspection unit 11 takes time to perform an inspection, it is possible to improve the efficiency of the operation of the inspection unit 11 by determining, by the DNN 119, whether the acceptable image and the unacceptable image of the unknown pair images are appropriate for the inspection by the inspection unit 11, in advance.

Note that, although description has been made above by using the pair images including the acceptable images and the unacceptable images of the wiring pattern, the present invention is not limited to the wiring pattern, and any pair images may be used as long as the pair images include acceptable images and unacceptable images of products that are mass-produced (mass-produced products).

Furthermore, although the mode in which machine learning is performed by using the pseudo pair images 1 of the rank 2 has been described above, the pseudo pair images 1 of the rank 2 do not have to be used.

Furthermore, although the mode in which machine learning is performed by using the pseudo pair images 2 of the ranks 3 to 6 has been described above, the pseudo pair images 2 of all of the ranks 3 to 6 do not have to be used. Among the ranks 3 to 6, the most important is the rank 6, in which both the acceptable image and the unacceptable image are erroneously determined. Therefore, only the pseudo pair images 2 of the rank 6 may be used.

Furthermore, either the rank 4 (excessive determination) or the rank 5 (overlooking determination) may be used. For example, in a case where one of the ranks 4 and 5 tends to be less likely to occur, a rank that tends to be less likely to occur does not have to be used. Furthermore, either one may be selected depending on a type of a product, or the like.

Furthermore, instead of using the rank 3, for example, the ranks 4 to 6 may be used. This is because, in the ranks 4 to 6, at least one of the acceptable image and the unacceptable image is erroneously determined.

Furthermore, the mode in which the pseudo image generation processing for generating the pseudo pair images 1 of the rank 2 and the pseudo pair images 2 of the ranks 3 to 6 includes the processing by the variational auto encoder method and the processing using the GAN has been described above.

However, the pseudo image generation processing is not limited to the processing including the processing by the variational auto encoder method and the processing using the GAN. For example, instead of the processing by the variational auto encoder method, processing of mixing an acceptable image and an unacceptable image at an optional ratio may be performed, or an averaging processing of obtaining an average image of an acceptable image and an unacceptable image may be performed. In the case of the averaging processing, for example, by taking an average of four acceptable images and one unacceptable image, an average image in which the acceptable image and the unacceptable image are 80:20 may be generated.

Furthermore, instead of the processing using the GAN, as the processing of creating pseudo images, image processing in which noise is superimposed, or processing in which an image is translated, rotated, smoothed, enlarged, reduced, or the like may be used.

Furthermore, the mode has been described above in which, to generate the acceptable image and the unacceptable image of the rank 2, by using the variational auto encoder method, the mixed acceptable image obtained by mixing the acceptable image and the unacceptable image of the rank 1 at the ratio of 100% and 0% and the mixed unacceptable image obtained by mixing the acceptable image and the unacceptable image of the rank 1 at the ratio of 0% and 100% are created. This substantially means that the processing by the variational auto encoder method is not performed.

However, the mixing ratio of the acceptable image and the unacceptable image for generating the acceptable image and the unacceptable image of the rank 2 is not limited to 100% and 0%, and the acceptable image and the unacceptable image may be mixed.

Furthermore, the mode has been described above in which, to generate the acceptable images and the unacceptable images of the ranks 3 to 6, by using the variational auto encoder method, the mixed acceptable image obtained by mixing the acceptable image and the unacceptable image of the rank 1 at the ratio of 80% and 20%, respectively, and the mixed unacceptable image obtained by mixing the acceptable image and the unacceptable image of the rank 1 at the ratio of 20% and 80%, respectively are created.

However, the mixing ratio for generating the acceptable images and the unacceptable images of the ranks 3 to 6 is not limited to 80%:20% and 20%:80%, and the mixing ratio may be changed as appropriate.

Although the information processing apparatus, the information processing program, and the information processing method of the exemplary embodiment of the present invention have been described above, the present invention is not limited to the embodiment disclosed in detail, and various changes and alterations may be made hereto without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor being configured to perform processing, the processing including:
executing a first image acquisition processing that acquires a plurality of determined pair images that includes acceptable images and unacceptable images, for which acceptance has been correctly determined by a first inspection program that has undergone first machine learning;
executing a first image generation processing that generates first pseudo pair images that includes acceptable images and unacceptable images obtained by performing first pseudo image generation processing on the acceptable images and the unacceptable images of the determined pair images;
executing a determination result acquisition processing that acquires determination results obtained by determining, by the first inspection program, acceptance of the acceptable images and the unacceptable images of the first pseudo pair images;
executing a ranking processing that ranks, on the basis of the determination results, the first pseudo pair images for which acceptance has been determined by the first inspection program, according to correctness of the determination for each pair;
obtaining a mathematical model represented by a second inspection program that determines, when an acceptable image and an unacceptable image of pair images are input, whether it is appropriate to cause the first inspection program to determine acceptance of the acceptable image and the unacceptable image of the pair images; and
executing a learning processing that causes the mathematical model to be trained by second machine learning that uses the determined pair images and the ranked first pseudo pair images as inputs,
wherein the first image generation processing generates the first pseudo pair images until the number of the ranked first pseudo pair images becomes a first predetermined number or more, and
by causing the mathematical model to be trained by the second machine learning that uses the determined pair images and the first predetermined number or more of the ranked first pseudo pair images as inputs, the learning processing trains the mathematical model such that, when an acceptable image and an unacceptable image of unknown pair images are input to the mathematical model, the mathematical model determines that it is appropriate to cause the first inspection program to determine acceptance of the acceptable image and the unacceptable image of the unknown pair images in a case where the acceptable image and the unacceptable image of the unknown pair images correspond to a predetermined rank or more, and determines that it is inappropriate to cause the first inspection program to determine acceptance of the acceptable image and the unacceptable image of the unknown pair images in a case where the acceptable image and the unacceptable image of the unknown pair images correspond to less than the predetermined rank.

2. The information processing apparatus according to claim 1, the processing further comprising:
executing a second image generation processing that generates second pseudo pair images that includes acceptable images and unacceptable images obtained by performing second pseudo image generation processing in which a degree of image change is lower than a degree of image change in the first pseudo image generation processing on the acceptable images and the unacceptable images of the determined pair images; and
executing a second image acquisition processing that acquires the second pseudo pair images for which the first inspection program has correctly determined acceptance of the acceptable images and the unacceptable images of the second pseudo pair images,
wherein the second image generation processing generates the second pseudo pair images until the number of the second pseudo pair images acquired by the second image acquisition processing becomes a second predetermined number or more, and
as the second machine learning, the learning processing causes the mathematical model to undergo the second machine learning that uses the determined pair images, the first predetermined number or more of the ranked first pseudo pair images, and the second predetermined number or more of the second pseudo pair images acquired by the second image acquisition processing as inputs.

3. The information processing apparatus according to claim 1, wherein
the ranking according to the correctness of the determination includes ranks for the first pseudo pair images for which acceptance of the acceptable images and the unacceptable images of the first pseudo pair images obtained by performing the first pseudo image generation processing has been erroneously determined by the first inspection program,
the first image generation processing generates the first pseudo pair images until the number of the first pseudo pair images for which acceptance has been erroneously determined for each of the ranks becomes a predetermined number for each of the ranks or more, and
the first predetermined number or more of the ranked first pseudo pair images used by the learning processing for the second machine learning are the predetermined number for each of the ranks or more of the first pseudo pair images.

4. The information processing apparatus according to claim 3, wherein, for the predetermined number for each of the ranks, the predetermined number for the first pseudo pair images for which acceptance of both the acceptable images and the unacceptable images obtained by performing the first pseudo image generation processing has been erroneously determined is greater than the predetermined number for the first pseudo pair images for which acceptance of one of the acceptable images and the unacceptable images obtained by performing the first pseudo image generation processing has been erroneously determined.

5. The information processing apparatus according to claim 4, wherein the predetermined rank is one of a rank for the first pseudo pair images for which acceptance of both the acceptable images and the unacceptable images obtained by performing the first pseudo image generation processing has been erroneously determined, a rank for the first pseudo pair images for which acceptance of one of the acceptable images and the unacceptable images obtained by performing the first pseudo image generation processing has been erroneously determined, and a rank for the first pseudo pair images for which acceptance of another one of the acceptable images and the unacceptable images obtained by performing the first pseudo image generation processing has been erroneously determined.

6. The information processing apparatus according to claim 3, wherein
the ranking according to the correctness of the determination further includes a rank for the first pseudo pair images for which acceptance of the acceptable images and the unacceptable images of the first pseudo pair images obtained by performing the first pseudo image generation processing has been correctly determined by the first inspection program,
the first image generation processing generates the first pseudo pair images until the number of the first pseudo pair images for which acceptance has been erroneously determined for each of the ranks becomes the predetermined number for each of the ranks or more, and until the number of the first pseudo pair images for which acceptance has been correctly determined becomes a predetermined number for the first pseudo pair images, and
the first predetermined number or more of the ranked first pseudo pair images used by the learning processing for the second machine learning are the predetermined number for each of the ranks or more of the first pseudo pair images and the predetermined number for the first pseudo pair images or more of the first pseudo pair images for which acceptance has been correctly determined.

7. The information processing apparatus according to claim 1, wherein
the first image generation processing generates the first pseudo pair images until the number of the first pseudo pair images for which acceptance of both the acceptable images and the unacceptable images of the first pseudo pair images has been erroneously determined among the ranked first pseudo pair images becomes a third predetermined number or more, and
the first predetermined number or more of the ranked first pseudo pair images used by the learning processing for the second machine learning include the third predetermined number or more of the first pseudo pair images for which acceptance of both the acceptable images and the unacceptable images of the first pseudo pair images has been erroneously determined.

8. The information processing apparatus according to claim 7, wherein
the first image generation processing further generates the first pseudo pair images until the number of the first pseudo pair images for which acceptance of one of the acceptable images and the unacceptable images of the first pseudo pair images has been erroneously determined by the first inspection program among the ranked first pseudo pair images becomes a fourth predetermined number or more, and
the first predetermined number or more of the ranked first pseudo pair images used by the learning processing for the second machine learning include the third predetermined number or more of the first pseudo pair images for which acceptance of both the acceptable images and the unacceptable images of the first pseudo pair images has been erroneously determined and the fourth predetermined number or more of the first pseudo pair images for which acceptance of one of the acceptable images and the unacceptable images of the first pseudo pair images has been erroneously determined.

9. The information processing apparatus according to claim 8, wherein the predetermined rank is one of a rank for the first pseudo pair images for which acceptance of both the acceptable images and the unacceptable images of the first pseudo pair images has been erroneously determined, a rank for the first pseudo pair images for which acceptance of one of the acceptable images and the unacceptable images of the first pseudo pair images has been erroneously determined by the first inspection program, and a rank for the first pseudo pair images for which acceptance of another one of the acceptable images and the unacceptable images of the first pseudo pair images has been erroneously determined by the first inspection program.

10. The information processing apparatus according to claim 8, wherein
the first image generation processing further generates the first pseudo pair images until the number of the first pseudo pair images for which acceptance of both the acceptable images and the unacceptable images of the first pseudo pair images has been correctly determined by the first inspection program among the ranked first pseudo pair images becomes a fifth predetermined number or more, and
the first predetermined number or more of the ranked first pseudo pair images used by the learning processing for the second machine learning are the third predetermined number or more of the first pseudo pair images for which acceptance of both the acceptable images and the unacceptable images of the first pseudo pair images has been erroneously determined, the fourth predetermined number or more of the first pseudo pair images for which acceptance of one of the acceptable images and the unacceptable images of the first pseudo pair images has been erroneously determined, and the fifth predetermined number or more of the first pseudo pair images for which acceptance of both the acceptable images and the unacceptable images of the first pseudo pair images has been correctly determined.

11. The information processing apparatus according to claim 7, wherein
the first image generation processing further generates the first pseudo pair images until the number of the first pseudo pair images for which acceptance of both the acceptable images and the unacceptable images of the first pseudo pair images has been correctly determined by the first inspection program among the ranked first pseudo pair images becomes a fifth predetermined number or more, and
the first predetermined number or more of the ranked first pseudo pair images used by the learning processing for the second machine learning include the third predetermined number or more of the first pseudo pair images for which acceptance of both the acceptable images and the unacceptable images of the first pseudo pair images has been erroneously determined, and the fifth predetermined number or more of the first pseudo pair images for which acceptance of both the acceptable images and the unacceptable images of the first pseudo pair images has been correctly determined.

12. The information processing apparatus according to claim 11, wherein the predetermined rank is a rank for the first pseudo pair images for which acceptance of both the acceptable images and the unacceptable images of the first pseudo pair images is erroneously determined.

13. A non-transitory computer-readable storage medium storing an information processing program for causing a computer to execute processing comprising:
acquiring a plurality of determined pair images that includes acceptable images and unacceptable images, for which acceptance has been correctly determined by a first inspection program that has undergone first machine learning;
generating first pseudo pair images that includes acceptable images and unacceptable images obtained by performing first pseudo image generation processing on the acceptable images and the unacceptable images of the determined pair images;
acquiring determination results obtained by determining, by the first inspection program, acceptance of the acceptable images and the unacceptable images of the first pseudo pair images;
ranking, on the basis of the determination results, the first pseudo pair images for which acceptance has been determined by the first inspection program, according to correctness of the determination for each pair; and
causing a mathematical model represented by a second inspection program that determines, when an acceptable image and an unacceptable image of pair images are input, whether it is appropriate to cause the first inspection program to determine acceptance of the acceptable image and the unacceptable image of the pair images to undergo second machine learning that uses the determined pair images and the ranked first pseudo pair images as inputs,
wherein the generating the first pseudo pair images is generating the first pseudo pair images until the number of the ranked first pseudo pair images becomes a first predetermined number or more, and
the causing the mathematical model to undergo the second machine learning is, by causing the mathematical model to undergo the second machine learning that uses the determined pair images and the first predetermined number or more of the ranked first pseudo pair images as inputs, training the mathematical model such that, when an acceptable image and an unacceptable image of unknown pair images are input to the mathematical model, the mathematical model determines that it is appropriate to cause the first inspection program to determine acceptance of the acceptable image and the unacceptable image of the unknown pair images in a case where the acceptable image and the unacceptable image of the unknown pair images correspond to a predetermined rank or more, and determines that it is inappropriate to cause the first inspection program to determine acceptance of the acceptable image and the unacceptable image of the unknown pair images in a case where the acceptable image and the unacceptable image of the unknown pair images correspond to less than the predetermined rank.

14. A computer-implemented information processing method comprising:
acquiring a plurality of determined pair images that includes acceptable images and unacceptable images, for which acceptance has been correctly determined by a first inspection program that has undergone first machine learning;
generating first pseudo pair images that includes acceptable images and unacceptable images obtained by performing first pseudo image generation processing on the acceptable images and the unacceptable images of the determined pair images;
acquiring determination results obtained by determining, by the first inspection program, acceptance of the acceptable images and the unacceptable images of the first pseudo pair images;
ranking, on the basis of the determination results, the first pseudo pair images for which acceptance has been determined by the first inspection program, according to correctness of the determination for each pair; and
causing a mathematical model represented by a second inspection program that determines, when an acceptable image and an unacceptable image of pair images are input, whether it is appropriate to cause the first inspection program to determine acceptance of the acceptable image and the unacceptable image of the pair images to undergo second machine learning that uses the determined pair images and the ranked first pseudo pair images as inputs,
wherein the generating the first pseudo pair images is generating the first pseudo pair images until the number of the ranked first pseudo pair images becomes a first predetermined number or more, and
the causing the mathematical model to undergo the second machine learning is, by causing the mathematical model to undergo the second machine learning that uses the determined pair images and the first predetermined number or more of the ranked first pseudo pair images as inputs, training the mathematical model such that, when an acceptable image and an unacceptable image of unknown pair images are input to the mathematical model, the mathematical model determines that it is appropriate to cause the first inspection program to determine acceptance of the acceptable image and the unacceptable image of the unknown pair images in a case where the acceptable image and the unacceptable image of the unknown pair images correspond to a predetermined rank or more, and determines that it is inappropriate to cause the first inspection program to determine acceptance of the acceptable image and the unacceptable image of the unknown pair images in a case where the acceptable image and the unacceptable image of the unknown pair images correspond to less than the predetermined rank.
